(19) United States
(12) Patent Application Publication
(10) Pub. No.: US 2020/0175449 A1
(43) Pub. Date: Jun. 4, 2020

(54) PERSONALIZED TASK BOX LISTING

(71) Applicant: SAP SE, Walldorf (DE)

(72) Inventors: Volker Lehmann, Mühlhausen (DE); Stefan Henke, Altlussheim (DE); Michael Sutter, Wiesloch (DE); Tobias Breyer, Mannheim (DE)

(21) Appl. No.: 16/208,789

(22) Filed: Dec. 4, 2018

(51) Int. Cl. G06Q 10/06; H04L 29/06

(52) U.S. Cl. CPC G06Q 10/06316; H04L 63/0807; G06Q 10/063114; G06Q 10/0633

(57) ABSTRACT

The present disclosure involves systems, software, and computer implemented methods for a personalized task ranking system capable of ranking tasks based on task context and user attributes. One example system includes operations to receive a request via interactions with an interface from a client device. User attributes associated with the request are identified. Context attributes corresponding to each task are identified from the repository of contextual content. Relevance conditions corresponding to each of the tasks are identified. The relevance conditions for each of the tasks are evaluated by comparing each of the context attributes to the user attributes. Based on the evaluating, a relevance score is generated for each of the tasks included in the task list corresponding to the user. The task list is transmitted with the generated relevance score for each of the tasks included in the task list to the client device.

### TECHNICAL FIELD

The present disclosure relates to computer-implemented methods, software, and systems for a personalized task ranking system based on task context and user attributes.

### BACKGROUND

Task lists refer to a list of tasks that needs to be accomplished within a defined period of time or by a deadline to work towards work-related goals. A task can be broken down into assignments, which can have a defined start and end date or a deadline for completion. One or more assignments on a task puts the task under execution by one or more users, in which one specific user can claim the task. Completion of a specific task normally renders the task completed. Task lists can be managed by software applications, where tasks relevant to a particular user can be presented to a user interface or application page of the particular user.

### SUMMARY

The present disclosure involves systems, software, and computer implemented methods for a personalized task ranking system based on task context and user attributes. One example system includes a request received via interactions with an interface from a client device associated with an authenticated user, wherein the interface is associated with presentation of a task list and manages interactions between the client device and the task list. Next, one or more user attributes associated with the request are identified. One or more context attributes corresponding to each task included in the task list are identified from the repository of contextual content. One or more relevance conditions corresponding to each of the tasks found in the task list are identified. The one or more relevance conditions for each of the tasks are evaluated by comparing each of the one or more context attributes to the one or more user attributes. Based on the evaluation, a relevance score is generated for each of the tasks included in the task list corresponding to the user. The task list with the generated relevance score for each of the tasks included in the task list is transmitted to the client device of the user.

Implementations can option include one or more of the following features. In some instances, the task list includes one or more categories, the one or more categories include at least a relevance score, a role, a group, a skillset, a task, user attributes, context attributes of the task, and metadata.

In some instances, the token data is transmitted to an identity provider with a request for authentication and verification of the taken data for the user. Confirmation data is received from the identity provider that the token data is authenticated and verified for the user, wherein the confirmation data includes additional user attribute data corresponding to the client device of the user.

In some instances, the additional user attribute data corresponds to static user data.

In some instances, generating the relevance score for each of the tasks include in the task list corresponding to the user further includes storing the generated relevance score for each of the tasks included in the task list before receiving a subsequent request from the user.

In some instances, selection data is received from the client device indicating of a selection of at least one category by the user to rank the task list in an inbox. The selection data is stored to use for generating the relevance scores for each of the tasks included in the task list.

In some instances, the client device is configured to present the task list in a prioritized order based on the generated relevance scores for each of the tasks included in the task list based on the transmitted task list.

Similar operations and processes may be performed in a system comprising at least one process and a memory communicatively coupled to the at least one processor where the memory stores instructions that when executed cause the at least one processor to perform the operations. Further, a non-transitory computer-readable medium storing instructions which, when executed, cause at least one processor to perform the operations may also be contemplated. In other words, while generally described as computer implemented software embodied on tangible, non-transitory media that processes and transforms the respective data, some or all of the aspects may be computer implemented methods or further included in respective systems or other devices for performing this described functionality. The details of these and other aspects and embodiments of the present disclosure are set forth in the accompanying drawings and the description below. Other features, objects, and advantages of the disclosure will be apparent from the description and drawings, and from the claims.

### DESCRIPTION OF DRAWINGS

FIG. 1 is a block diagram illustrating an example system for a personalized task ranking system based on task context and user attributes.

FIG. 2 is a data and control flow of example interactions performed by a workflow management system that provides a task list with relevance scores based on task context and user attributes.

FIG. 3 is an alternative block diagram illustrating a general example system for a personalized task ranking system based on task context and user attributes.

FIG. 4 is a flowchart of an example method performed by a workflow management system in connection with a client device for personalizing a task list based on task context and user attributes.

### DETAILED DESCRIPTION

The present disclosure describes various tools and techniques associated with a personalized task ranking system capable of ranking tasks based on task context and user attributes. Recipients of user tasks in a workflow system are normally assigned to specific user roles which resolve into an arbitrary number of users who may, as a consequence, see instances of those tasks in their inbox. In particular, users with a medium to large amount of tasks in their inbox struggle to find the most relevant task upon which to work on first. Additionally, even with a smaller number of tasks in the inbox, it is desirable to have a meaningful display order to simplify choosing the next task upon which to work on.

In current systems, tasks are primarily sortable by metadata of the task instance only, such as creation date or task priority. However, an improved experience described herein includes the ability to order and prioritize available tasks for a user based on a user-specific relevance, which may be determined by substantially different factors and may rely on individual factors for respective users. In one example, a task which requests face-to-face contact with a colleague might be highly relevant for a user, as the user may be closely located to the person the user would be required to meet. In another example, a user may be subscribed to receive support tickets (such as, workflow tasks). In that instance, a ticket might be received that is of less relevance to a user, as that particular user is not an expert for that topic of the ticket. In order to alleviate the issues with relevancy, the following illustrating determining suitable ordering of open and available tasks in an inbox for an individual user. The user, in this instance, can remain a potential processor of the task, allowing him/her to also work on low ranked tasks if decided to.

In some instances, in order to determine a ranking of tasks for a particular user's inbox, a workflow management system calculates a user-specific score per task, thereby expressing the relevance of a particular task for a particular user. The workflow management system relies on modelled expressions of relations between user attributes to the context (such as, the task or workflow) or metadata to determine an individual relevance score. Additionally, users can include or assign custom user attributes, such as “Skills,” “Board Area,” “Job Function,” etc. In some instances, user attributes are associated with the user and are stored and managed in a central, company-wide user directory. These individual attributes can then be put into relation with context attributes of tasks to calculate the relevance score of the task for a user.

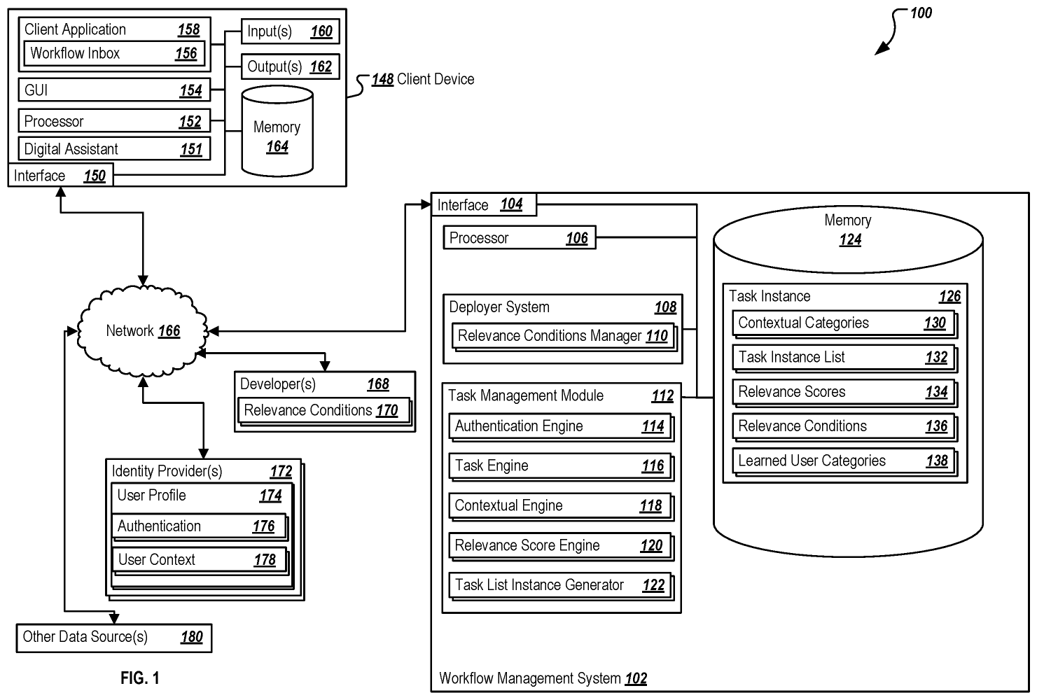

Turning to the illustrated example illustration, FIG. 1 is a block diagram illustrating an example system 100 for a personalized task ranking system based on task context and user attributes. System 100 includes functionality and structure associated with receiving inputs from client device 148 (associated with a user), analyzing the received input at the workflow management system 102 to identify an intent of the input, identifying one or more user attributes of the request, and identifying one or more context attributes corresponding to each task found in the task list. The workflow management system 102 compares the one or more context attributes corresponding to each of the tasks to the one or more user attributes. The workflow management system 102 can determine whether a match exists between the one or more context attributes corresponding to each of the tasks and the one or more user attributes based on a relevance condition. Based on the comparison and the determination, the workflow management system 102 can generate a relevance score for each of the tasks found in the task list corresponding to the user. In response, the workflow management system 102 can transmit the task list with the generated relevance score for each of the tasks found in the task list to the client device of the user.

The illustrated system 100 includes or is communicably coupled with a workflow management system 102, a client device 148, a developer 168, one or more external data sources 180, and a network 166. System 100 is a single example of a possible implementation, with alternatives, additions, and modifications possible for performing some or all of the described operations and functionality. Although shown separately, in some implementations, functionality of two or more systems, servers, or illustrated components may be provided by a single system or server. In some implementations, the functionality of one two or more systems, servers, or illustrated components may be provided by a single system or server. In some implementations, the functionality of one illustrated system or server may be provided by multiple systems, servers, or computing devices, including those physically or logically local or remote to each other. Any combination or permutation of systems may perform the functionality described herein. In some implementations, particular operations and functionality described herein may be executed at either the client device 148, the workflow management system 102, or at one or more other non-illustrated components, as well as at a combination thereof.

As used in the present disclosure, the term “computer” is intended to encompass any suitable processing device. For example, client device 148 and the workflow management system 102 may be any computer or processing device (or combination of devices) such as, for example, a blade server, a general-purpose personal computer (PC), MAC, workstation, UNIX-based workstation, embedded system or any other suitable device. Moreover, although FIG. 1 illustrated particular components as a single element, those components may be implemented using a single system or more than those illustrated, as well as computers other than servers, including a server pool or variations that include distributed computing. In other words, the present disclosure contemplates computers other than general-purpose computers, as well as computers without conventional operating systems. Client device 148 may be any system which can request data, execute an application (e.g., client application 158), and interact with the workflow management system 102, the deployer system 108, and the task management module 112. The client device 148, in some instances, may be any other suitable device, including a mobile device, such as a smartphone, a tablet computing device, a smartwatch, a laptop/notebook computer, a connected device, or any other suitable device. Additionally, the client device 148 may be a desktop or workstation, server, or any other suitable device. Similarly, the workflow management system 102 may be a server, a set of servers, a cloud-based application or system, or any other suitable system. In some instances, the client device 148 may execute on or be associated with a system executing the workflow management system 102. In general, each illustrated component may be adapted to execute any suitable operating system, including Linux, UNIX, Windows, Mac OS®, Java™, Android™, Windows Phone OS, or iOS™, among others.

The workflow management system 102 can perform functionality associated with one or more deployer systems 108, one or more task management modules 112, can perform operations associated with receiving input from a client device 148 (e.g., via interface 150) associated with the interface 104, and can analyze the received input to determine a context or an intent of the input (e.g., a particular question, a query, a comment, or a request to execute an application, or other communication to which a response may be generated for the interface 103). Using the determined context or the determined intent of the input, the workflow management system retrieves each task from the task list and compares one or more context attributes from each task of the task list to one or more user attributes associated with the request. In response, the workflow management system 102 generates a relevance scores for each task found in the task list corresponding to the user.

As illustrated, the workflow management system 102 includes an interface 104, a processor 106, a deployer system 108, a task management module 112, and a memory 124. Different implementations may include additional or alternative components, with FIG. 1 meant to be an example illustration of one possible implementations. While illustrated separate from one another, at least some of these components, in particular, the deployer system 108 and the task management module 112, may be combined within a single component or system, or may be implemented separate from one another, including at different systems and/or at remote components.

Interface 104 is used by the workflow management system 102 for communicating with other systems in a distributed environment—including within the system 100—connected to the workflow management system 102 and/or network 166, e.g., client device 148, developer 168, and identity provider 172, as well as other systems or components communicably coupled to the network 166. Generally, the interface 104 includes logic encoded in software and/or hardware in a suitable combination and operation to communicate with network 166 and other communicably coupled components. More specifically, the interface 104 may comprise software supporting one or more communication protocols associated with communications such that the workflow management system 102, network 166, and/or interface's hardware is operable to communicate physical signals within and outside of the illustrated system 100.

Network 166 facilitates wireless or wireline communications between the components of the system 100 (e.g., between combinations of the workflow management system 102, client device(s) 148, and/or other components, among others), as well as with any other local or remote computer, such as additional mobile devices, clients, servers, remotely executed or located portions of a particular component, or other devices communicable coupled to network 166, including those not illustrated in FIG. 1. In this illustrated environment, the network 166 is depicted as a single network, but may be comprised of more than one network without departing from the scope of this disclosure, so long as at least a portion of the network 166 may facilitate communication between senders and recipients. In some instances, one or more of the illustrated components (e.g., the workflow management system 102) or portions thereof (e.g., the deployer system 108, the task management module 112) may be included within network 166 as one or more cloud-based services or operations. The network 166 may be all or a portion of an enterprise or secured network, while in another instance, at least a portion of the network 166 may represent a connection to the internet. In some instances, a portion of the network 166 may be a virtual private network (VPN) or an Intranet. Further all or a portion of the network 166 can comprise either a wireline or wireless link. Example wireless links may include 802.11a/b/g/n/ac, 802.20, WiMax, LTE, and/or any other appropriate wireless link. In other words, the network 166 encompasses any internal or external network, networks, sub-network, or combination thereof operable to facilitate communications between various computing components inside and outside the illustrated system 100. The network 166 may communicate, for example, Internet Protocol (IP) packets, Frame Relay frames, Asynchronous Transfer Mode (ATM) cells, voice, video, data, and other suitable information between network addresses. The network 166 may also include one or more local area networks (LANs), radio access networks (RANs), metropolitan area networks (MANs), wide area networks (WANs), all or a portion of the internet and/or any other communication system or systems at one or more locations.

The workflow management system 102 also includes one or more processors 106. Although illustrated as a single processor 106 in FIG. 1, multiple processors may be used according to particular needs, desires, or particular implementations of the system 100. Each processor 106 may be a central processing unit (CPU), an application specific integrated circuit (ASIC), a field-programmable gate array (FPGA), or another suitable component. Generally, the processor 106 executes instructions and manipulates data to perform the operations of the workflow management system 102, in particular, those related to executing the various modules illustrated therein and their related functionality. Specifically, the processor 106 executes the algorithms and operations described in the illustrated figures, as well as the various software modules and functionalities, including the functionality for sending communications to and receiving transmissions from the client device 148, the developer 168, and the identity provider(s) 172, as well as to process and prepare resources to receive input associated with the task management module 112. Each processor 106 may have a single core or multiple cores, with each core available to host and execute an individual processing thread.

Regardless of the particular implementations, “software” includes computer-readable instructions, firmware, wired and/or programmed hardware, or any combination thereof on a tangible medium (transitory or non-transitory, as appropriate) operable when executed to perform at least the processes and operations described herein. In fact, each software component may be fully or partially written or described in any appropriate computer language including C, C++, Objective-C, JavaScript, Java™ Visual Basic, assembler, Perl®, Swift, HTML5, any suitable version of 4GL, as well as others.

As illustrated, the workflow management system 102 includes, is associated with, and/or executes the deployer system 108. The deployer system 108 may be a program, module, component, agent, or any other software component which manages and conducts interactions via auditory or textual methods with the one or more developer(s) 168 to deploy one or more relevance conditions. In some instances, the deployer system 108 may be executed remotely from the task management module 112, where the task management module 112 performs operations associated with identifying one or more user attributes from the received request, identifying one or more context attributes corresponding to each task found in the task list, determining whether a match exists between the user attributes and the context attributes, and scoring each task found in the task list based on the comparison. The deployer system 108 may be accessed via a website, a web service interaction, a particular application (e.g., client application 158), or it may be a backend portion of a digital or virtual assistant application or functionality of a particular operating system, such as Apple's Siri, Google's Assistant, Amazon's Alexa, Microsoft's Cortana, or others. In some instances, a remote agent or client-side portion of the deployer system 108 may execute at the client device 148, where inputs can be provided and responses can be presented to the user of the client device 148, while some or all of the processing is performed at the workflow management system 102.

In some instances, the system 100 can include one or more developer(s) 168. Each of the developers can generate one or more relevance conditions 170. In some instances, the relevance conditions can be defined as the context variable that are expected to have an influence on the relevance of the task and the mapping to values of specific user attributes. For example, the developer(s) 168 can define a relevance condition in one or more settings, such as an environmental, professional, or business setting. The relevance condition can include a comparison between user attributes of a user and context attributes of a task. For example, for a context attribute for a task, such as, “Budget,” can be determined to be larger than a predetermined dollar amount, such as $1,000 corresponding to a user attribute “Job Function” of manager. Thus, in this case, the developer is setting the condition that the task is of greater relevance for users with the job title of “Managers” and for which the budget of the task is larger than $1,000. In another example, a context attribute for a “machine part” task includes “engine”. In this second example, the user attribute for “skills” includes “engine.” Thus, the developer(s) 168 can create a relevance condition that seeks to match the task of an “engine” to a user that includes a user attribute of “engine.” In another example, for a task relating to “machine part,” the relevance condition can seek to determine a user that includes a user attribute of “machine part” in skills. In another example, given a task instance with a context value of “engine” for context attribute of “machine part” would evaluate to a higher relevance score for a user with value “engine” in user attribute “skills” than a user that includes “gearbox” in his/her user attribute “skills.”

The developer(s) 168 can generate the one or more relevance conditions 170 and transmit the one or more relevance conditions 170 to the workflow management system 102. In particular, the workflow management system 102 detects that the deployer system 108 has received the one or more relevance conditions 170 and provides the one or more relevance conditions 170 to the relevance conditions manager 110 of the deployer system 108. The relevance conditions manager 110 stores the one or more relevance conditions 170 in the memory 124. Additionally, the relevance conditions manager 110 can transmit a notification to the developer(s) 168 in response to detecting an error with a condition from the one or more relevance conditions 170. For example, if the developer(s) 168 creates a relevance condition that seeks to match a context attribute for a “computer part” is “processor” to “skills” of a user attribute that includes “engine,” the relevance conditions manager 110 can determine that these content attributes should not match to this type of user attribute. The relevance conditions manager 110 can determine whether the context from the context attribute matches the context of the user attributes for a particular relevance condition. In some instances, the relevance conditions manager 110 performs a context matching check for each particular relevance condition 170 before storing each relevance condition 170 in memory 124.

In some instances, the workflow management system 102 can additionally include a task management module 112. The task management module 112 can include an authentication engine 114, a task engine 116, a contextual engine 118, a relevance score engine 120, and a task list instance generator 122. The task management module 112 can include any suitable natural language processing engine, and performs operations related to receiving a set of input from the client device 148, understanding the set of receiving input received at the workflow management system 102. Examples of this type of module could be used or implemented including a plurality of web services and backend applications, including IBM's Watson, Google Cloud Natural Language API, Amazon Lez, Microsoft Cognitive Services, as well as any proprietary solution, application, or service. The processing performed by the task management module 112 can include processing the received input by identifying a context or intent associated with the input received via the workflow management system 102. The task management module 112 can additionally parse the received input to retrieve one or more keywords from the received input. The result of the processing input by the task management module 112 can be a set of lexical semantics of the received input, which can be further used by different components of the task management module 112. In some instances, the result produced by the task management module 112 can include a string, a short code, or a set of semantics that describes the intent of the received input.

The task management module 112 includes an authentication engine 114. The authentication engine 114 can be configured to communicate with an identity provider 172. The identity provider 172 can be a separate entity from the workflow management system 102. The identity provider 172 can include a user profile 174 that includes authentication 176 and user context 178, for each particular user. The authentication engine 114 can communicate with the user profile 174 to obtain additional information about a particular user profile associated with the received input. The authentication engine 114 can retrieve data associated with a particular user profile (determined from the received input) from a plurality of user profiles 174. In some instances, the authentication engine 114 can identify a set of preferences previously defined by the user or determined based on previous interactions and other user operations corresponding to the user profile 174. Additionally, the user profile 174 for a particular user can also include social network data that may identify particular social network profiles and/or login credentials associated with one or more social networks. The authentication engine 114 can use that information to access a particular social network (e.g., Facebook, Twitter, Reddit, Instagram, etc.) and obtain information about particular social network activities of the user, including particular persons, entities, and other accounts with which the user follows, likes, or otherwise has interacted with as defined by a social network included in the user profile 174, where that information identifies particular public personalities or entities with which later persona-based content and enhancements can be used. In some instances, at least some of the information may be available within the social network data without requiring the authentication engine 114 or another component to access the social networks at the time of the interaction with the task management module 112. In some instances, the identity provider 172 may include location information associated with the user found in the user profile 174, or may be accessible via the client device 148 or other means. The location information can be static information, such as current address of the user, email address, and/or an IP/MAC address of the user's client device 148. Additionally, the identity provider 172 may include dynamic location information, such as GPS coordinates of the client device 148. In some instances, the location information associated with the user found in the user profile 174 is retrieved from a request transmitted by the client device 148.

The authentication engine 114 may communicate with the authentication 176 for a particular profile to authenticate the user. The authentication 176 can be used by the workflow management system 102 to identify and/or verify the credentials of the user. In particular, when a user provides a request from the client device 148 to the workflow management system 102, that request may be associated with or can include one or more credentials of the user. For example, the one or more credentials can include a username, a password, a token for authentication, and other authentication credential data. Upon the workflow management system 102 receiving the requested input, the authentication engine 114 can retrieve the one or more credentials from or associated with the requested input to determine which user sent the request. In particular, the authentication engine 114 can compare the one or more credentials in the request to each authentication 176 corresponding to a user profile 174 until a match is found. Once the authentication engine 114 finds a match between the one or more credentials in the received input to a particular authentication 176 in a corresponding user profile 174, the authentication engine 114 can determine who the user is that sent the received input and/or can confirm that the identification provided by or associated with the request is authenticated from the client device 148. In some instances, the authentication engine 114 can generate an authentication credential in response to determining the credentials of the user matches the one or more stored credentials. The generated authentication credential can include one or more keys, a token, an identifier of the accepted credential, or another credential. Additionally, the authentication engine 114 can provide the generated authentication credential back to the client device 148 indicating that client device is authenticated to communicate with the workflow management system 102.

In response to the authentication engine 114 authenticating the client device 148 for a particular user profile 174, the authentication engine 114 retrieves user context 178 data from the user profile 174. If the authentication engine 114 did not authenticate the client device 148, then the authentication engine 114 can decline the request transmitted by the user. In some instances, the authentication engine 114 retrieves user context 178 corresponding to the user that transmitted the request. For example, the user context 178 can include user attribute data indicating that the user is an “IT specialist,” his employer is located in Washington DC, he is employed at an IT company, his one or more skills include computer debugging, network development, computer architecture organization, writing software, developing hardware, and writing microprocessor instructions. Additionally, the user context 178 can include the user's salary and the career track the user is on. The user context 178 can also include one or more restrictions of prioritizations placed on the user for particular tasks. For example, when a particular task corresponds to a high budget monetary amount, such as $100,000, the task is ranked higher for a particular user, as higher tasked budgets typically correlate to relevance of importance. In another example, a task can be prioritized lower for a particular user when that task falls under a department that does not coincide with his skills, such as the human resources department if the user's skills include topics such as “engine mechanic,” “field labor,” or “hardware analysis”, to name a few examples. In another example, the user may require permission or authorization from his/her boss to work on a particular task for a particular client before the system prioritizes a particular task. The authentication engine 114 retrieves each of the attributes for a particular user profile 174 from the user context 178 of the identity provider 172 and stores this data.

In some instances, the authentication engine 114 provides the authentication data of the client device 148 and the data from the user profile 174 corresponding to the user that transmitted the request to the task engine 116. The task engine 116 communicates with the authentication engine 114 and the task instance list 132. In some instances, the task engine 116 retrieves each task from the task instance list 132. Each task found in the task instance list 132 can be set by a task list manager. A task list manager can delegate each of the tasks to one or more employees corresponding to the workflow management system 102. For example, the tasks can include fixing a known problem, writing a particular email to a client, entering in time for a timesheet, or writing a performance review, to name a few examples. In some instances, a task list manager can delegate multiple individuals to work on a particular task. However, as will be further described below, the individual with the closest attributes to the context/attributes of the task will have the highest relevance score in completing a desired task.

In some instances, the task engine 116 transmits each retrieved task and data received from the authentication engine 114 to the contextual engine 118. The contextual engine 118 communicates with the task engine 116 and the contextual categories 130. In particular, the contextual engine 118 communicates with the contextual categories 130 to retrieve one or more contextual categories corresponding to each task in the task list. Each task in the task list can include one or more categories such as a relevance score, a role, a group, a skillset, user attributes, context attributes of the task, and metadata. The relevance score will be further explained below. For example, for a task such as debugging computer hardware to solve a processing issue, the one or more categories can include a relevance score of 95%, a role of IT user, a skillset corresponding to hardware fixes, user attributes of the user corresponding to an IT specialist, IT department, product development, and software debugging, for a particular IT employee. Additionally, context attributes of the task corresponding to “computers,” “hardware,” “debugging,” and “processor,” and metadata corresponding to a date the task was created, a user who created the task, and a location where the task is meant to be completed, such as a conference room.

The contextual engine 118 can retrieve each of these contextual categories corresponding to each task found in the task list. In some instances, the contextual engine 118 can transmit the data received from the task engine 116 and the data retrieved from the contextual categories 130 to the relevance score engine 120. In some instances, the contextual engine 118 can transmit a location in memory 124 that the data received from the task engine 116 and the data retrieved from the contextual categories 130 is stored. The contextual engine 118 may store this data in memory 124 and transmit the address to the relevance score engine 120 when the data size exceeds a predetermined threshold, such that it cannot be transmitted.

In some instances, the relevance score engine 120 receives the data associated with or from the contextual engine 118. Using the data associated with the contextual engine 118, the relevance score engine 120 retrieves the relevance conditions from the relevance conditions database 136. The relevance conditions database 136 includes the data from the developer(s) 168. In particular, the relevance score engine 120 selects and/or retrieves the user attributes from the user that transmitted the request to match the context attributes for each task using the relevance conditions. Each task in the task list includes an explicit task definition or an implicit task definition. The explicit task definition for a particular task includes the static, up-front properties of a task. These static, up-front properties can include a static subject or expression that indicates how a subject is structured and responsibility information. For example, the static subject or expression and responsibility information can be “job to hire new employees” and “all managers,” respectively. This would indicate that the explicit task definition would include that “if you are manager, then you perform a job for hiring new employees.” The implicit task definition for a particular task includes relevance conditions, such as associations and relations that associate them with the static properties for a given task from the task list. Thus, an implicit task definition can include an additional condition. For example, the task can be for “job to hire new employees” and the relevance condition that that this be performed by “all managers located within Washington D.C. that work on the 11^{th} floor.” Thus, the implicit task definition would indicate that “if you are a manager, you are located in Washington DC, and you work on the 11^{th} floor, then you perform a job for hiring new employees.” The relevance score engine 120 can use the user attributes from the request, the contextual attributes from the particular task, and the relevance task condition to generate a relevance score of a task for a particular user.

The relevance score engine 120 matches each of the context attributes for a particular task to each of the user attributes from the request sent by the user. In response to the match, the relevance score engine 120 generates a relevance score for each task of a task list for a particular user. For example, for a task A that includes a description that recites “draft proposal,” the relevance score engine 120 will retrieve contextual attributes for the “draft proposal” task. These contextual attributes can include “drafting,” “writing,” creativity,” and “proposals.” Additionally, for a task B that includes a description that recites “computer memory issue,” the relevance score engine 120 will retrieve contextual attributes for the “computer memory issue” that can include “computer,” “IT specialist,” “memory,” “debugging,” and “programming.” The relevance score engine 120 can retrieve attributes associated with/or corresponding to the user that transmitted the request. These user attributes can include “computer,” “engineer,” “located in server-room,” “debugger,” “JAVA,” “C++,” “Python,” “Engineer III,” and “database manager.” The relevance score engine 120 can then generate a relevance score for this user to task A and task B.

Task A can include an explicit task definition, such that “if you work in managing, you will draft proposals.” Task B can include an implicit task definition, such that “if you work in engineering, are employed higher than an Engineer II, and are located in the conference room, then you are to fix the computer memory issue. For task A, using the corresponding relevance condition, the contextual attributes of task A, and the user attributes that transmitted the request, the relevance score engine 120 does not match the user to task A because the user's attributes relate to computer programming and the relevance condition for task A seeks a user that is a manager. Thus, the relevance score engine 120 gives the “task A” a relevance score of 5% for the user, a relatively low score based on the user attributes, the context attributes of the task, and the given relevance condition for task A. For task B, using the corresponding relevance condition, the contextual attributes of task B, and the user attributes that transmitted the request, the relevance score engine 120 matches the user to task B because the user's attributes relate to computer programming, which matches the context attributes, and the corresponding relevance condition. For example, the relevance condition for task B indicates that the following conditions have to be met—“working in engineering,” “employed higher than an Engineer II,” and “located in a conference room.” Per the user's attributes, the user attributes do indicate the user is an engineer (e.g., “engineer”) and the user is employed as an Engineer III, but the user is not located in the conference room. Rather, the user is located in the server room. Thus, the relevance score engine 120 can generate a relevance score of 95% for Task B for this particular user. Additionally, the relevance score engine 120 can match other user attributes (not ones found to be matched based on the relevance condition) to context attributes to add to the relevance score rating. For example, since both user attributes and contextual attributes include the same label of “computer,” the relevance score engine 120 can take this match into consideration for generating the relevance score. Thus, the newly generated relevance score for task B for this particular user is now 96% instead of 95%.

In some instances, the relevance score engine 120 can also take in to account the current location of the user to factor in the relevance score rating. Continuing with the previous example, if the relevance score engine 120 determines that the “server room” where the user is located in next door to the “conference room” where the task B's location is, the relevance score engine 120 can also increase the relevance score to 97%, instead of 96%. Thus, the relevance score engine 120 takes into account various factors for calculating the relevance score. The relevance score engine 120 performs this step for each task found in the task list.

In some instances, the relevance score engine 120 stores the generated relevance score for each task for a particular user in the relevance scores database 134. These relevance scores can be retrieved the next time the user sends a request for accessing his/her inbox. Additionally, the relevance score engine 120 retrieves one or more learned user categories from learned user categories database 138. The learned user categories database 138 stores categories the user prefers to see when viewing his/her inbox. For example, each category can include a role, a group, a skillset, a task, user attributes, context attributes of the task, relevance score, and metadata. The learned user categories database 138 stores indications of selections made by the user for ranking the task in his/her inbox. Each time the user selects a category to rank a task listing in his/her inbox, the client device 148 transmits a notification to the workflow management system 102 to indicate the selection of ranked category made by a user. The workflow management system 102 stores this selection in the learned user categories database 138. These selections can be accumulated over a period of time to determine how the user prefers to rank his/her task listings. Thus, the next time the user transmits a request to access his/her inbox, the workflow management system 102 can generate an inbox with task listings ranked by user preferred categories based on previous user category selections.

The task list instance generator 122 receives the data from the relevance score engine 120 and generates the new task list to transmit to the client device 148. In particular, the task list instance generator 122 receives the task list, each relevance score corresponding to the task in the task list, each of the categories corresponding to the task list, and any learned user categories. The task list instance generator 122 formulates the task list in order of at least one of the relevance score, the learned user categories, or a category randomly selected, to name a few examples. By ranking the task list by the relevance score, the user can view the task listings in order of most relevancy to the user. The task list instance generator 122 transmits the generated task list and corresponding categories to the client device 148 over the network 166 for the user to view.

As illustrated, the workflow management system 102 includes memory 124. In some instances, the workflow management system 102 includes a single memory or multiple memories. The workflow management system 102 may include any type of memory or database module and may take the form of volatile and/or non-volatile memory including, without limitation, magnetic media, optical media, random access memory (RAM), read-only memory (ROM), removable media, or any other suitable local or remote memory component. The memory 124 may store various objects or data, include caches, classes, frameworks, applications, backup data, business objects, jobs, web pages, web page templates, database tables, database queries, repositories storing business and/or dynamic information, and any other appropriate information including any parameters, variables, algorithms, instructions, rules, constraints, or references thereto associated with the purposes of the workflow management system 102. Additionally, the memory 124 may store any other appropriate data, such as VPN applications, firmware logs and policies, firewall policies, a security or access log, print or other reporting files, as well as others. As illustrated, memory 124 includes a task instance database 126 that includes contextual categories 130, task instance list 132, relevance score database 134, relevance conditions database 136, and learned user categories database 138, described herein. Memory 124 may be local to or remote to the workflow management system 102, and may be available remotely via network 166 or an alternative connection in such instances where not locally available. Further, some or all of the data in memory 124 in FIG. 1 may be located outside of the workflow management system 102, including within network 166 as cloud-based storage and data.

Illustrated system 100 includes at least one client device 148 and may include a plurality of client devices 148 in some instances. Each client device 148 may generally be any computing device operable to connect to or communicate within the system 100 via network 166 using a wireline or wireless connection. In general, the client device 148 comprises an electronic computer device operable to receive, transmit, process, and store any appropriate data associated with the system 100 of FIG. 1. As illustrated, the client device 148 can include one or more client application, including the client application 158 and digital assistant 151. In some instances, the digital assistant 151 may be a part of the operating system executing on the client device 148, or may be a standalone application or client-side agent of a backend application. In some instances, the client device 148 may comprise a device that includes one or more input(s) 160, such as a keypad, touch screen, camera, or other device(s) that can interact with the client application 158 and/or digital assistant 151 and other functionality, and one or more output(s) 162 that covey information associated with the operation of the applications and their application windows to the user of the client device 148. The output(s) 162 can include a display, speakers, or any other suitable output component. The information presented by the output(s) can include digital data, visual information, auditory output, or a graphical user interface (GUI) 154, as shown with respect to the client device 148. In general, client device 148 includes an electronic computer device operable to receive, transmit, process, and store any appropriate data associated with the system 100 of FIG. 1.

Client application 158 can be any type of application that allows the client device 148 to request and view content on the client device 148. In some instances, client application 158 may correspond with one or more backend appliances or functionality, including an application or platform associated with the workflow management system 102. In some instances, the client application 158 can be associated with a workflow inbox 156, where the workflow inbox displays to the user a list of task instances. The user can initiate a request to view the workflow inbox 156 and receive output from the workflow management system 102 that displays the workflow inbox 156.

In some instances, the client device 148 may be a mobile device, including but not limited to, a smartphone, a tablet computing device, a laptop/notebook computer, a smartwatch, or any other suitable device capable of interacting with the workflow management system 102 and in particular, the deployer system 108 and the task management module 112. One or more additional client application 158 may be present on a client device 148, and can provide varying functionality for users. In some instances, client application 158 may be a web browser, mobile application, cloud-based application, or dedicated remote application or software capable of interacting with at least some of the illustrated systems via network 166 to request information from and/or respond to one or more of those systems.

The digital assistant 151 may be any interactive artificial or virtual intelligence component, agent, or other functionality that can be interacted with by a user, either textually or verbally through one or more input(s) 160 (e.g., a microphone), manually through one or more input(s) 160 (e.g., physical or virtual keyboards, touch screen buttons or controls, other physical or virtual buttons, etc.), or through captured gestures or movements identified by the client device 148. In general, the digital assistant 151 may be a software agent, module, or component, among others, that can perform tasks or services for an individual in response to one or more inputs, and can include or represent a particular conversational interface associated with the workflow management system 102. As indicated, any one of numerous commercial examples may be used, as well as other proprietary or application-specific assistants. The digital assistant 151 may work and interact via text (e.g., chat), voice, image submission, or other suitable inputs. Some virtual assistants can interpret input using natural language processing (NLP) to match user text or voice input to executable commands. In some instances, the digital assistant 151 can be interacted with to initiate and perform one or more input and response interactions described herein. In some instances, the digital assistant 151 may be a standalone application (e.g., Google Assistant executing on an iPhone), functionality included in a particular application used for other purposes (e.g., an Alexa-enabled Amazon app), or an agent or other functionality built into the operating system (e.g., Siri on Apple's iOS).

As illustrated, the client device 148 may also include an interface 150 for communication (similar to or different from interface 150), a processor 152 (similar to or different from processor 106), memory 164 (similar to or different from memory 124), and GUI 154. GUI 154 can interface with at least a portion of the system 100 for any suitable purpose including generating a visual representation of the client application 158 and/or the digital assistant 151, presenting a pop-up or push notification or preview thereof, presenting the UI associated with the interface 150, or any other suitable presentation of information. GUI 154 may also be used to view and interact with various web pages, applications, and web services located local or external to the client device 148, as well as information relevant to the client application 158. Generally, the GUI 154 provides the user with an efficient and user-friendly presentation of data provided by or communicated within the system. The GUI 154 may comprise a plurality of customizable frames or views having interactive fields, pull-down lists, and buttons operated by the user. For example, the GUI 154 may provide interactive elements that allow a user to view or interact with information related to the operations of processes associated with the workflow management system 102 and any associated systems, among others. In general, the GUI 154 is often configurable, supports a combination of tables and graphs (bar, line, pie, status dials, etc.), and is able to build real-time portals, application windows, and presentations. Therefore, the GUI 154 contemplates any suitable graphical user interface, such as a combination of a generic web browser, a web-enabled application, intelligent engine, and command line interface (CLI) that processes information in the platform and efficiently presents the results to the user visually.

The external data sources 180 illustrated in FIG. 1 may be any other data sources source that provides additional information to the workflow management system 102. The information may be used by the deployer system 108 and/or task management module 112 to determine a particular response to the received input as described herein. Any number of data sources 180 may be used in alternative implementations.

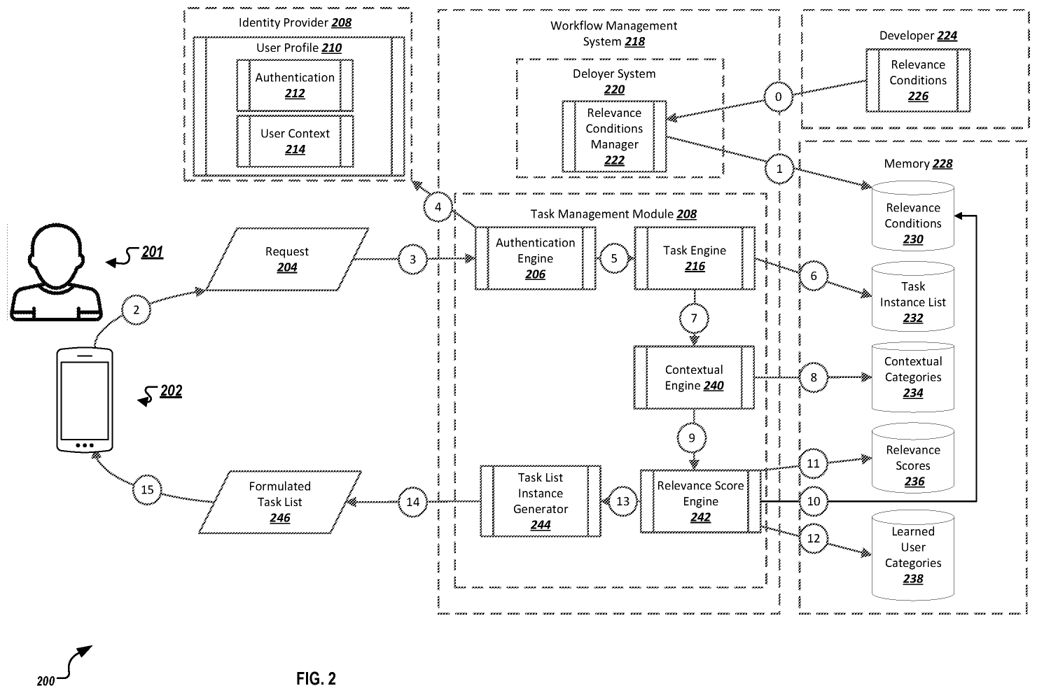

FIG. 2 is a data and control flow of example interactions 200 performed by a workflow management system that provides a task list with relevance scores based on task context and user attributes. The diagram provides an example of set of operations and interactions to receive a response, authenticate the user that transmitted the response, determine user attributes of the user that transmitted the request, retrieve task instances corresponding to a task list, retrieve corresponding context attributes for each task from the task list, match the context attributes for each task to user attributes from the user that transmitted the request, generate a relevance score based on the match for each task, and providing a response based to the user that includes a new generated task list with the relevant scores for each task. A user 201 uses a client device 202 to provide the request. In the illustrated example, user 201 can interact with an interface of a client device 202, a workflow management system 218 (include a deployer system 220 and a task management module 208), a developer 224, and a memory 228. These components may be similar to or different from the components described in FIG. 1.

As illustrated, a developer 224 provides one or more relevance conditions 226 to the workflow management system 218 (0). Each of the one or more relevance conditions corresponds to a particular task. A developer can set multiple relevance conditions for each task. In addition, a developer can set one or explicit task definitions and one or more implicit task definitions for each relevant condition that corresponds to a task.

The workflow management system 218 receives and processes the relevance conditions 226 (1). In particular, the relevance conditions manager 222 within the deployer system 220 of the workflow management system 218 processes each of the received relevance conditions 226. The relevance conditions manager 222 determines if one or more errors exist with each of the relevance conditions 226. If the relevance conditions manager 222 determines an error exists with a relevance condition, the relevance conditions manager 222 transmits data indicating the error and the particular relevance condition to the developer 224, such that the developer 224 can correct the error. For example, the relevance conditions manager 22 may determine that for a particular relevance condition, a user attribute of “IT programmer” is desired to match with a context attribute “hardware development.” The relevance conditions manager 222 can determine that the user attribute of “IT programmer” and context attribute “hardware development” should not match, and thus, flag an error for the developer 224.

In response to determining each of the relevance conditions appear to be correct, the relevance conditions manager 222 transmits the relevance conditions to the relevance conditions database 230. The relevance conditions manager 222 stores the relevance conditions based on each task in the relevance conditions database 230. In some instances, the relevance conditions can be indexed by a task in the relevance conditions database 230.

Additionally, as illustrated in FIG. 2, the user 201 interacts with a client device 202 to provide a request 204 to the workflow management system 218 (3). In particular, the request 204 is provided or transmitted to the authentication engine 206 for authenticating the user 201 or another user associated with the input (4). In particular, the authentication engine 206 can retrieve one or more credentials from or associated with the received input (e.g., username, password, token, and/or key) and compare the one or more credentials to the authentication portion of each user profile 210. Once the authentication engine 206 determines a match exists, the authentication engine 206 can use the authentication 212 from the matched user profile 210 to authenticate the user 201. The authentication engine 206 an obtain and provide one or more authentication credentials from the authentication 212 back to the client device 202 for authenticating subsequent conversations from the client device 202. Additionally, the authentication engine 206 can provide the authentication credentials to other various components of the task management module 208.

In response to the authentication engine 206 matching to a user profile 210 and matching the credentials provided by the user to the authentication 212 corresponding to the user profile 210, the authentication engine 206 retrieves one or more user attributes from user context 214 corresponding to the user profile 210. For example, the user context 214 can include can include information including the static locational data of the user, employee classification data of the user that can include user roles, personal data, office location, company/department, job function, one or more task that the user can perform with his role, and one or more skills of the user. The user context 214 can additionally include permissions/restrictions placed on one or more tasks for the user 201, as well as, employment information of the user 201.

The authentication engine 206 provides the data from the request 204, the authentication 212, and the user context 214 to the task engine 216 (5). The task engine 216 can communicate with the authentication engine 206, the task instance list 232, and the contextual engine 240. The task engine 216 can retrieve the task list that includes the one or more tasks from the task instance list 232 (6). An external party, such as a task list manager, a supervisor, or a developer, can set and/or delegate each of the tasks to one or more individuals that are authenticated to communicate with the workflow management system 218. For example, the tasks can include fixing a known problem, such as a hardware or software issue, drafting an email to a client or colleague, creating a PowerPoint to present to a supervisor, and writing a performance review, to name a few examples. Each time a new task is provided by an external user, the task engine 216 can add the task to the task instance list 232.

In some instances, the task engine 216 provides the data from the authentication engine 206 and data corresponding to each retrieved task from the task list to the contextual engine 240 (7). The contextual engine 240 can communicate with the task engine 216, the contextual categories database 234, and the relevance score engine 242. In response to receiving the data from the task engine 216, the contextual engine 240 communicates with the contextual categories database 234 to retrieve one or more contextual categories corresponding to each task found in the task list (8). The contextual engine 240 can retrieve data from the contextual categories database 234 corresponding to one or more categories for each task in the task list. For example, the one or more categories can include a relevance score, a role, a group, a skillset, user attributes, context attributes corresponding to the task, and additional metadata. For example, for a task that includes drafting a memo to a particular client, the relevance score can be blank until the relevance score engine 242 calculates the relevance score for the particular user. In other instances, the relevance score may be a previously determined relevance score for this task for the particular user. The role can include draftsmen. The skillset required to work on this task can include “writing,” “creativity,” “proposal writing,” and “client relationship skills.” The context attributes corresponding to the task (e.g., that describe the task) can include “proposals,” “computers,” and “writing application.” The metadata corresponds to the date the task was created, a user that created the task, a location where the task is meant to be completed, a completion date, and a budget corresponding to the task.

The contextual engine 240 can generate data to transmit that includes the received contextual categories from the contextual categories database 234, data received from the authentication engine 206, and data from the user profile 210. The contextual engine 240 transmits this generated data to the relevance score engine 242 or transmit a location of where the generated data is stored in memory 228 for the relevance score engine 242 to access (9).

In some instances, in response to receiving the data from the contextual engine 240, the relevance score engine 242 retrieves the relevance conditions from the relevance conditions database 230 (10). The developer(s) 224 can set the one or more relevance conditions for each of the tasks found in the relevance conditions database 230. The relevance score engine 242 retrieves each of the one or more relevance conditions corresponding to each of the one or more tasks to generate a relevance score for each of the tasks in the task list received from the contextual engine 240. In some instances, the relevance conditions found in the relevance conditions database 230 may be indexed by the tasks themselves. In other instances, the relevance score engine 242 may retrieve each of the non-indexed relevance conditions from the relevance conditions database 230.

Next the relevance score engine 242 generates the relevance score for each task found in the task list. In particular, the relevance score engine 242 selects and/or retrieves the user attributes from the user that transmitted the request (e.g., data from the user profile 210 and data from the request 204) to match the context attributes for each task using the corresponding relevance conditions. In particular, as previously described, each task can include at least an explicit task definition or an implicit task definition. For example, an explicit task definition can include how responsibility information is matched to particular criteria. Additionally, an implicit task definition can include how responsibility information is matched to particular criteria and can include one or more additional conditions. An explicit task definition example can be, “if a user is greater than an Engineer II, then a user writes his/her own performance reviews.” An implicit task definition example can be, “if a user is greater than an Engineer II, has one or more employees that are to be managed, and works in NYC, then that user writes his/her own performance reviews.” Thus, the relevance score engine 242 can retrieve the user attributes from the request (204) and from the selected user profile 210, the determined contextual attributes from the particular task, and the determined relevance task condition (e.g., either explicit task definition, implicit task definition, or both) to generate a relevance score of that task for a particular user.

The relevance score engine 242 can match each of the context attributes for the particular task to each of the user attributes from the request 204 (and the user profile 210) transmitted by the user to match the relevance condition. In response to the matching, the relevance score engine 120 generates a relevance score for each task in the task list. For example, the relevance score engine 120 can score a task A for user 201 to have a relevance score of 90% and score a task B for user 201 to have a relevance score of 70%. The relevance score engine 242 can take in to account additional factors to adjust the relevance score for a particular task, such as the location of the current location of the user, the location of the task, the distance between the current location of the user and the location of the task, as well as the completion deadline for a particular task.

In response to generating each of the relevance scores for each of the tasks, the relevance score engine 242 can store the generated relevance score for each of the tasks in the relevance scores database 236 (11). Subsequently, the relevance score engine 242 can retrieve the relevance scores for a particular task the next time the user transmits a request for accessing his or her inbox (e.g., request 204). The relevance score engine 242 can determine if the previous score matches the currently determined score for a particular task. If the scores are within a predetermined threshold (e.g., such as 2%, for example), then the relevance score engine 242 can discard the previously generated scores stored in the relevance scores database 236 and update the relevance scores database 236 with the newly generated relevance scores. Alternatively, if the scores are greater than the predetermined threshold (e.g., such as 3%), then relevance score engine 242 can add the newly generated relevance scores to the tasks, such that the tasks in the relevance scores database 236 has multiple relevance scores from previous determinations.

In some instances, the relevance score engine 242 can transmit a request to the learned user categories database 238 in response to generating the relevance scores for each task in the task list for a particular user. The learned user categories database 238 stores categories that a particular user prefers to see when viewing his/her inbox showing a particular task list. In particular, the learned user categories database 238 stores indication of selections made by a particular user for ranking the task list by category. For example, the user can rank the task list in his/her inbox by a role, a group, a skillset, a task, one or more user attributes, one or more context attributes of the task, relevance score, and metadata. The task can be ranked for each category in alphabetical order, in ascending/descending order of the relevance score, or by matching types of each category. Each time a user selects a category to rank a task listing by in his/her inbox, the client device 202 transmit a notification to the workflow management system 218 that stores the notification of the selection in the learned user categories database 238. The notification indicates a selection of a particular category for ranking the task list in his/her inbox. In some instances, these selections made by the user can be accumulated over a period of time to determine how likely a user is to view the task listings ranked based on a particular category. Thus, the next time the user submits a request 204 to view a task list in his/her inbox, the task list can be pre-ranked based on a category that a user typically prefers to view. In response to setting the ranking of the task list, the relevance score engine 242 transmits the generated data to the task list instance generator 244 (13).

The task list instance generator 244 receives the data from the relevance score engine 242 and generates the new task list to transmit to the client device 202. In particular, the task list instance generator 244 receives the task list, the one or more categories (e.g., including each relevance score for a task in the task list and corresponding categories for the task), and any learned user categories that user 201 prefers to view. In some instances, the task list instance generator 244 formulates a task list in order of at least one of the relevance score, the learned user categories, or a category randomly selected. In other instances, the task list instance generator 244 formulates a task list that is not ranked and allows the user to rank the formulated task list. In response to the task list instance generator 244 generating the formulated task list 246, the task list instance generator 244 transmits the formulated task list 246 to the client device 202 (14). The user 201 can view the formulated task list 246 on the client device 202 and interact with the formulated task list 246 (e.g., ranking, selecting, or deleting tasks) (15).

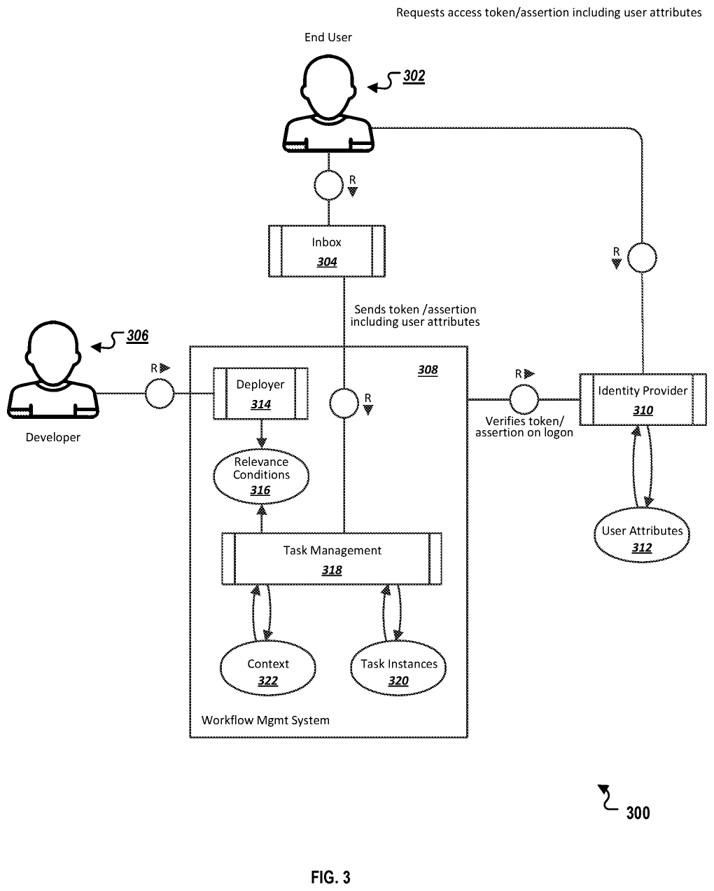

FIG. 3 is an alternative block diagram illustrating a general example system 300 for a personalized task ranking system based on task context and user attributes. In some instances, system 300 may be similar to and have similar components to interactions 200 and system 100. In particular, the system 300 has an end user 302 (e.g., using a client device) that can transmit a request for an inbox 304 to the workflow management system 308. The inbox 304 allows an end user 302 to view one or more tasks and corresponding categories in a task list on his or her client device. Additionally, the end user 302 can rank the one or more tasks in the task list by at least one of the one or more categories.

The workflow management system 308 can include a deployer 314, one or more relevance conditions 316, task management 318, task instances database 320, and content database 322. The workflow management system 308 can interact with external components, such as, for example, developer 306, identity provider 310, and user attributes 312. In particular, the developer 306 can provide one or more relevance conditions 316 to the deployer 314. After error checking the one or more relevance conditions 316, the deployer 314 can provide the one or more relevance conditions 316 to the task management 318. The one or more relevance conditions 316 can be used by the task management 318 to generate a relevance score for a particular task. Additionally, the task management 318 can communicate with the identity provider 310 to authenticate the end user 302 and to retrieve one or more user attributes for a particular end user in response to authenticating the end user 302.

The identity provider 310 communicates with user attributes 312 to retrieve one or more user attributes that correspond to an end user 302. User attributes 312 can be a database that stores static and dynamic user attributes for a particular end user 302. The end user 302 can transmit static and dynamic user attributes to the identity provider 310 to store in the user attributes 312. For example, static user attributes can include end user 302's home address, employee classification, salary, and job responsibilities. Dynamic user attributes can include end user 302's current location and information regarding end user 302's calendar activities.

The task management 318 can also communicate with the content database 322 and the task instances database 320. In particular, the task management 318 can retrieve one or more tasks in a task list from the task instances database 320. In response to retrieving the one or more tasks, the task management can retrieve one or more contextual attributes corresponding to each of the tasks in the task instances database 320. Using the contextual attributes for each of the tasks, the user attributes of the end user 302, and the relevance conditions 316 corresponding to each of the tasks, the task management 318 can generate a relevance score for each of the tasks. In response to generating a relevance score for each of the tasks, the task management 318 can associate each of the relevance scores for each of the tasks in a formulated task list and transmit the formulated task list to the end user's inbox 304. At the end user's inbox 304, the end user 302 can interact with the formulated task list by ranking the task lists by at least one of the categories.

In some instances, multiple users viewing a respective inbox may see similar task lists with different relevance scores for each of the tasks. For example, a user 1 may see task A with a relevance score of 90%, a task B with a relevance score of 50%, and a task C with a relevance score of 70%. Similarly, user 2 may also seek tasks A, B, and C, and see different relevance scores for the same tasks. For example, user 2 may see task A with a relevance score of 30%, task B with a relevance score of 25%, and a task C with a relevance score of 90%. Thus, in the workflow management system, different users can view the same tasks in his/her inbox with different scores for tasks that pertain to that user's relevancy.

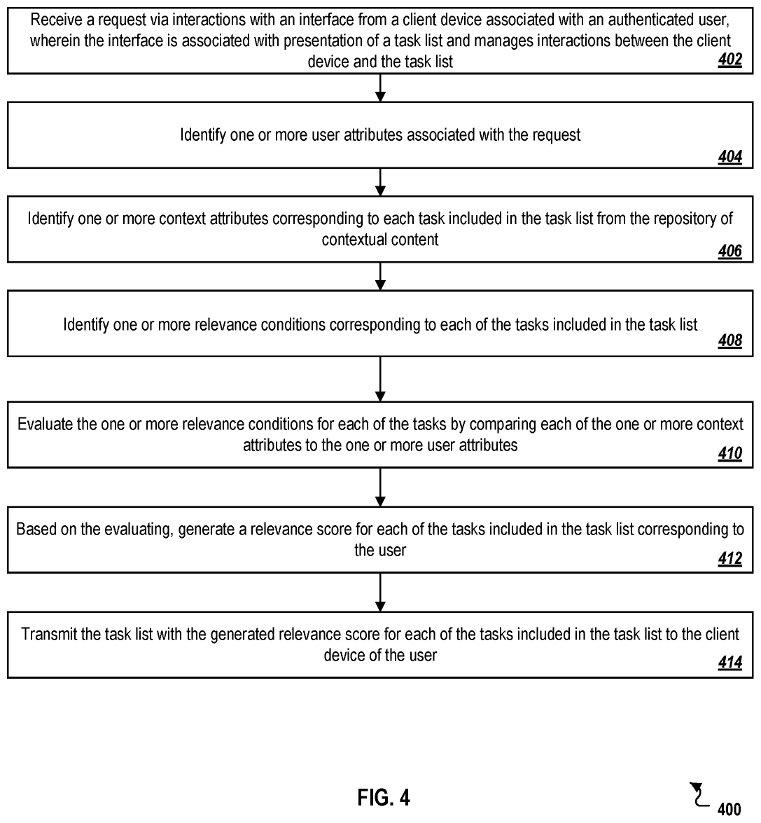

FIG. 4 is a flowchart of an example method 400 performed by a workflow management system in connection with a client device for personalizing a task list based on task context and user attributes. It will be understood that method 400 and related methods may be performed, for example, by any suitable system, environment, software, and hardware, or a combination of systems, environments, software, and hardware, as appropriate. For example, a system comprising a communications module, at least one memory storing instructions and other required data, and at least one hardware processor interoperably coupled to the at least one memory and the communications module can be used to execute method 400. In some implementations, the method 400 and related methods are executed by one or more components of the system 100 described above with respect to FIG. 1, or the components described in FIGS. 2 and 3.

At 402, a request is received via interactions with an interface from a client device. The client device can be associated with an authenticated user, and the interface can be associated with a task list to manage interactions between the client device and the task list in an inbox. In some instances, the request can include an identification of a particular user, a particular client device, or a particular user profile corresponding to the user associated with the request. In some instances, the request may be received at a specific endpoint associated with a particular interface or related application at the workflow management system. Examples may include a digital assistant or a particular website, where the request is to be responded to based on the information obtainable by or related to that particular interface or application.

In some instances, the request may be or may include text-based input, auditory input (e.g., an audio file), and/or video or image input. The request can be submitted by a user or agent associated with a particular user profile, although for purposes of some implementations of method 400, identification of the particular user profile is not needed to perform this process. In some instances, the received request can represent a particular query, question, or interactive communication. In some instances, the request may be automatically sent in response to a user's navigation to a particular application, application page, web page, or other location associated with a task list.

At 404, one or more user attributes associated with the request are identified. In response to the workflow management system authenticating the user that transmitted the request, the workflow management system identifies one or more user attributes. For example, the one or more user attributes can include data indicating that the user is an “IT specialist,” that the user's employer is located in Washington DC, that the user is employed at an IT company, and that the user's skills include computer debugging, network development, computer architecture organization, writing software, developing hardware, and writing microprocessor instructions. Additionally, the user context 178 can include the user's salary and the career track the user is on. The user context 178 can also include one or more restrictions placed on the user for particular tasks.

At 406, one or more context attributes corresponding to each task included in the task list from the repository of contextual content are identified. First, the workflow management system (e.g., the task engine) retrieves the tasks in the task list from the task instance list database. Using each of the tasks in the task list, the workflow management system (e.g., the contextual engine) retrieves the one or more contextual categories corresponding to each task in the task list. Each task in the task list can include one or more categories such as a relevance score, a role, a group, a skillset, user attributes, context attributes of the task, and metadata. For example, for a task such as debugging computer hardware to solve a processing issue, the one or more categories can include a relevance score of 95%, a role of IT user, a skillset corresponding to hardware fixes, user attributes of the user corresponding to an IT specialist, IT department, product development, and software debugging, for a particular IT employee. Additionally, context attributes of the task corresponding to “computers,” “hardware,” “debugging,” and “processor,” and metadata corresponding to a date the task was created, a user who created the task, and a location where the task is meant to be completed, such as conference room.

At 408, one or more relevance conditions corresponding to each of the tasks included in the task list are identified. The developer(s) can set the one or more relevance conditions for each of the tasks found in the relevance conditions database. The relevance score engine retrieves each of the one or more relevance conditions corresponding to each of the one or more tasks to generate a relevance score for each of the tasks in the task list received from the contextual engine. In some instances, the relevance conditions found in the relevance conditions database may be indexed by the tasks themselves. In other instances, the relevance score engine may retrieve each of the non-indexed relevance conditions from the relevance conditions database.

At 410, the one or more relevance conditions are evaluated for each of the tasks by comparing each of the one or more context attributes to the one or more user attributes. In particular, the workflow management system (e.g., the relevance score engine) can use the user attributes form the request, the contextual attributes from the particular task, and the relevance task condition to the task that is most relevant to a particular user. For example, the relevance score engine can match one or more contextual attributes of a task to user attributes of a user. The matches can be based off string matching, lesser/greater than comparisons, regular expression matching, as well complex function calls for assigning contextual attributes of a task to user attributes of a particular user. The relevance score engine can perform this operation for each task in the task list to determine a relative relevancy of a particular task for a particular user.

At 412, based on the evaluation, a relevance score is generated for each of the tasks included in the task list corresponding to the user. The relevance score engine generates a relevance score for each of the tasks for a particular user that indicates how well the user attributes of a particular user and the contextual attributes for a particular task match. For example, for a task A where the task requires “debugging a software program issue,” the relevance score engine may generate a relevance score for an “IT programmer” of 90%, whereas the relevance score engine may generate a relevance score of 40% for a task of “drafting a proposal” for the “IT programmer.” The relevance score engine can generate a relevance score for each task in the task list for that particular user.

At 414, the task list with the generated relevance score for each of the tasks included in the task list is transmitted to the client device of the user. In some instances, the workflow management system (e.g., the task list instance generator, in particular) formulates the task list with a generated relevance score for each task in the task list by a particular ranking. The ranking can include at least one of the relevance score, the learned user categories, or a category randomly selected, to name a few examples. By ranking the task list by the relevance score, the user can view the task listings in order of most relevancy to the user. In other instances, the task list instance generator does not rank the formulated task list, but generates a formulated task list and allows the user to rank the formulated task list for his or her choosing. Then, the task list instance generator transmits the generated task list and corresponding categories to the client device over the network for the user to view.

The preceding figures and accompanying description illustrate example processes and computer-implementable techniques. But system 100 (or its software or other components) contemplates using, implementing, or executing any suitable technique for performing these and other tasks. It will be understood that these processes are for illustration purposes only and that the described or similar techniques may be performed at any appropriate time, including concurrently, individually, or in combination. In addition, many of the operations in these processes may take place simultaneously, concurrently, and/or in different orders than as shown. Moreover, the described systems and flows may use processes and/or components with or performing additional operations, fewer operations, and/or different operations, so long as the methods and systems remain appropriate.

In other words, although this disclosure has been described in terms of certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

What is claimed is:

1. A computer-implemented method performed by one or more processors, the method comprising:
receiving a request via interactions with an interface from a client device associated with an authenticated user, wherein the interface is associated with presentation of a task list and manages interactions between the client device and the task list;
identifying one or more user attributes associated with the request;
identifying one or more context attributes corresponding to each task included in the task list from the repository of contextual content;
identifying one or more relevance conditions corresponding to each of the tasks included in the task list;
evaluating the one or more relevance conditions for each of the tasks by comparing each of the one or more context attributes to the one or more user attributes;
based on the evaluating, generating a relevance score for each of the tasks included in the task list corresponding to the user; and
transmitting the task list with the generated relevance score for each of the tasks included in the task list to the client device of the user.

2. The method of claim 1, wherein the task list comprises one or more categories, the one or more categories comprises at least a relevance score, a role, a group, a skillset, a task, user attributes, context attributes of the task, and metadata.

3. The method of claim 1, wherein the request comprises a user identification, the one or more user attributes, token data for identifying the user associated with the client device, and user context data.

4. The method of claim 3, further comprising:
transmitting the token data to an identity provider with a request for authentication and verification of the token data for the user; and
receiving, from the identity provider, confirmation data that the token data is authenticated and verified for the user, wherein the confirmation data comprises additional user attribute data corresponding to the client device of the user.

5. The method of claim 4, wherein the additional user attribute data corresponds to static user data.

6. The method of claim 1, wherein generating the relevance score for each of the tasks included in the task list corresponding to the user further comprises:
storing the generated relevance score for each of the tasks included in the task list before receiving a subsequent request from the user.

7. The method of claim 1, further comprising:
retrieving previous relevance scores corresponding to the task list for the user in response to receiving the request; and
transmitting the task list with the previous relevance scores to the client device of the user in response to determining a timing relevance condition falls within a predefined threshold, wherein the timing relevance condition indicates an amount of time between a subsequent request received from the user and the request received from the user.

8. The method of claim 2, further comprising:
receiving selection data from the client device indicating of a selection of at least one category by the user to rank the task list in an inbox; and
storing the selection data to use for generating the relevance scores for each of the tasks included in the task list.

9. The method of claim 1, wherein the client device, based on the transmitted task list, is configured to present the task list in a prioritized order based on the generated relevance scores for each of the tasks included in the task list.

10. A non-transitory, computer-readable medium storing computer-readable instructions executable by a computer and configured to:
receiving a request via interactions with an interface from a client device associated with an authenticated user, wherein the interface is associated with presentation of a task list and manages interactions between the client device and the task list;
identifying one or more user attributes associated with the request;
identifying one or more context attributes corresponding to each task included in the task list from the repository of contextual content;
identifying one or more relevance conditions corresponding to each of the tasks included in the task list;
evaluating the one or more relevance conditions for each of the tasks by comparing each of the one or more context attributes to the one or more user attributes;
based on the evaluating, generating a relevance score for each of the tasks included in the task list corresponding to the user; and
transmitting the task list with the generated relevance score for each of the tasks included in the task list to the client device of the user.

11. The computer-readable medium of claim 10, wherein the task list comprises one or more categories, the one or more categories comprises at least a relevance score, a role, a group, a skillset, a task, user attributes, context attributes of the task, and metadata.

12. The computer-readable medium of claim 10, wherein the request comprises a user identification, the one or more user attributes, token data for identifying the user associated with the client device, and user context data.

13. The computer-readable medium of claim 12, further comprising:
transmitting the token data to an identity provider with a request for authentication and verification of the token data for the user; and
receiving, from the identity provider, confirmation data that the token data is authenticated and verified for the user, wherein the confirmation data comprises additional user attribute data corresponding to the client device of the user.

14. The computer-readable medium of claim 13, wherein the additional user attribute data corresponds to static user data.

15. The computer-readable medium of claim 10, wherein generating the relevance score for each of the tasks included in the task list corresponding to the user further comprises:
storing the generated relevance score for each of the tasks included in the task list before receiving a subsequent request from the user.

16. The computer-readable medium of claim 10, further comprising:
retrieving previous relevance scores corresponding to the task list for the user in response to receiving the request; and
transmitting the task list with the previous relevance scores to the client device of the user in response to determining a timing relevance condition falls within a predefined threshold, wherein the timing relevance condition indicates an amount of time between a subsequent request received from the user and the request received from the user.

17. The computer-readable medium of claim 11, further comprising:
receiving selection data from the client device indicating of a selection of at least one category by the user to rank the task list in an inbox; and
storing the selection data to use for generating the relevance scores for each of the tasks included in the task list.

18. The computer-readable medium of claim 10, wherein the client device, based on the transmitted task list, is configured to present the task list in a prioritized order based on the generated relevance scores for each of the tasks included in the task list.

19. A computerized method performed by one or more processors, the method comprising:
receiving a request via interactions with an interface from a client device associated with an authenticated user, wherein the interface is associated with presentation of a task list and manages interactions between the client device and the task list;
identifying one or more user attributes associated with the request;
identifying one or more context attributes corresponding to each task included in the task list from the repository of contextual content;
identifying one or more relevance conditions corresponding to each of the tasks included in the task list;
evaluating the one or more relevance conditions for each of the tasks by comparing each of the one or more context attributes to the one or more user attributes;
based on the evaluating, generating a relevance score for each of the tasks included in the task list corresponding to the user; and
transmitting the task list with the generated relevance score for each of the tasks included in the task list to the client device of the user.

20. The method of claim 19, wherein the task list comprises one or more categories, the one or more categories comprises at least a relevance score, a role, a group, a skillset, a task, user attributes, context attributes of the task, and metadata.
